(19) United States
(12) Patent Application Publication
(10) Pub. No.: US 2023/0296810 A1
(43) Pub. Date: Sep. 21, 2023

(54) MULTILAYER FILM PROTECTOR FOR ELECTROMAGNETIC DEVICES

(71) Applicant: Tyler Shupe Richardson, Creve Coeur, MO (US)

(72) Inventor: Tyler Shupe Richardson, Creve Coeur, MO (US)

(21) Appl. No.: 18/184,986

(22) Filed: Mar. 16, 2023

Related U.S. Application Data
(60) Provisional application No. 63/269,432, filed on Mar. 16, 2022.

(51) Int. Cl. G02B 1/14; B32B 27/40

(52) U.S. Cl. CPC G02B 1/14; B32B 27/40; B32B 2307/412

(57) ABSTRACT

A transparent multilayer protective film for electromagnetic devices includes a barrier film; a hydrophobic polymer coated onto a first surface of the barrier film; and a pressure sensitive adhesive adhered to a second surface of the barrier film.

### CROSS-REFERENCE TO RELATED APPLICATION

This application claims the benefit of priority of U.S. provisional application No. 63/269,432, filed Mar. 16, 2022, the contents of which are herein incorporated by reference.

### BACKGROUND OF THE INVENTION

The present invention relates to electromagnetic devices such as vehicle cameras and, more particularly, to a multilayer film protector therefor.

Weather, debris, and lighting can each impair camera function. Rear view cameras on a vehicle do not work well in inclement weather such as rain or snow. Their function is also impaired when a vehicle is dirty and dust or dirt covers the camera lens. If camera function on a vehicle is impaired, this could result in an expensive or even deadly collision.

Currently available protective devices are typically bulky and unsightly mechanisms placed over the camera. The size of these mechanisms does not allow the mechanisms to fit on all cameras. Moreover, the mechanisms are prone to break, leaving the camera less functional and less effective. These mechanisms can also be hard to install, having difficult wiring.

As can be seen, there is a need for a simple, cost-effective solution to prevent a vehicle camera from impaired function.

### SUMMARY OF THE INVENTION

In one aspect of the present invention, a transparent multilayer protective film for electromagnetic devices comprises a barrier film having a first surface and a second surface; a hydrophobic polymer coated onto the first surface of the barrier film; and a pressure sensitive adhesive adhered to the second surface of the barrier film.

These and other features, aspects and advantages of the present invention will become better understood with reference to the following drawings, description, and claims.

### BRIEF DESCRIPTION OF THE DRAWINGS

FIG. 1 is a detail, exploded, rear perspective view of a lens cover according to an embodiment of the present invention, shown in use;

FIG. 2 is an exploded perspective view thereof; and

FIG. 3 is an enlarged sectional view thereof, taken on line 3-3 of FIG. 1

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a multilayer film protector for electromagnetic devices such as a camera lens.

A hydrophobic coated finish of the film may protect the camera from water and debris for consistent long-term clarity. The film may protect the camera lens against weather, salt, and chemical exposure. This enables a user to see clearly through the camera lens without an impaired view.

Preferably, once the protective product is applied, the film is not distinguishable from the camera lens and the edges of the film are not noticeable. Moreover, the protective product is not visible in video displayed from the camera in use. It may be transparent or semi-transparent such that it does not alter a user's view. This in turn improves driver visibility and therefore safety for driver and vehicle.

In some embodiments, the protective film may be comprised of several layers. For example, the protective article may have three layers. A first layer or topcoat which may be a self-healing hydrophobic coating effective to repel water and debris. The dimensions of the topcoat are not particularly limited. For example, the topcoat may be about 1 mil thick. The coating material is selected to adhere well to the layer upon which the coating is deposited.

The protective film may include a second or middle layer which may be a sturdy barrier polymer film, such that it is extremely difficult to damage. For example, the second layer may be a clear, flexible, polyurethane film. The dimensions are not particularly limited, provided that it remains sufficiently flexible to adhere to round or curved lenses without causing image distortion. For example, the film may be about 4-millimeter thick. It may be self-healing to prevent scratching.

The protective film may include a third layer which may be a pressure sensitive adhesive. The protective multilayer film may be easily installed onto a camera by applying the adhesive layer onto a lens surface of the camera.

The protective film article may comprise an adhesive having a first surface and a second surface, a low-density polymer, and a hydrophobic coating. The first adhesive surface may be affixed to the camera lens. The second adhesive surface may be secured to a first surface of a low-density polymer. A second surface of the low-density polymer may be coated with a hydrophobic coating.

The inventive protective article is not limited to use with cameras and may be used in a wide variety of applications, including sights for guns and electromagnetic sensors such as proximity or headway sensors, e.g., at the back and front of a vehicle. These sensors may include radar sensors, infrared sensors, ultrasonic sensors, and light detection and ranging (LIDAR) sensors. Moreover, the present invention is not limited to use on vehicle cameras. It may be applied to any camera with a lens, including but not limited to cell phone cameras, drone cameras and/or security (e.g., front door) cameras.

The present invention may be placed on any camera of a vehicle, without altering the vehicle or the camera and without any installation gear.

The protective article preferably withstands inclement weather, high speed movement such as that of a vehicle, and wear and tear associated with outdoor activity.

The multilayer film protector may be formed as a flat sheet. Alternatively, the multilayer film protector may be configured to conform to a lens. For example, the multilayer film protector may be formed with a domed shape.

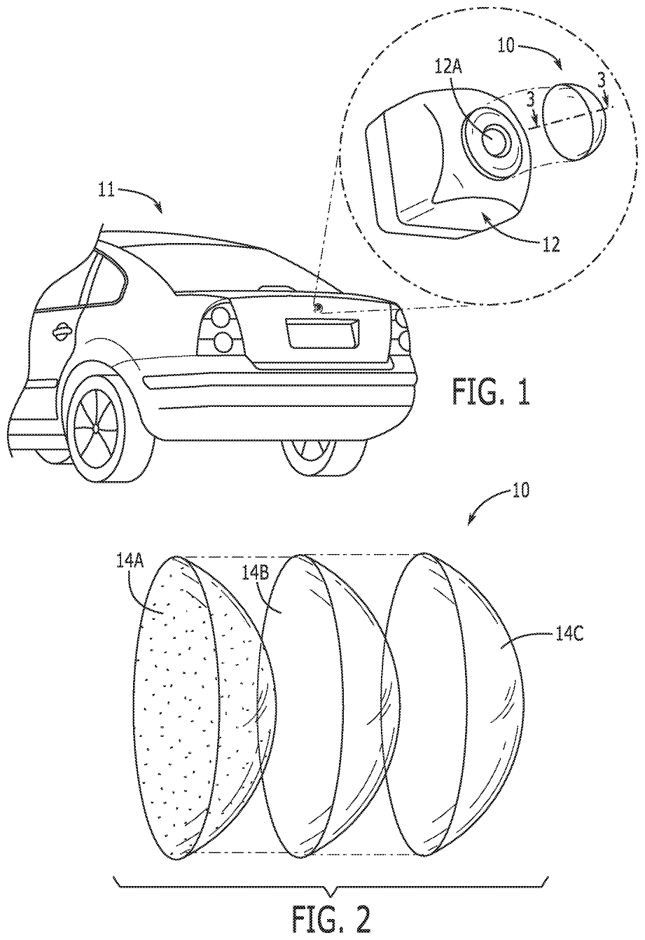

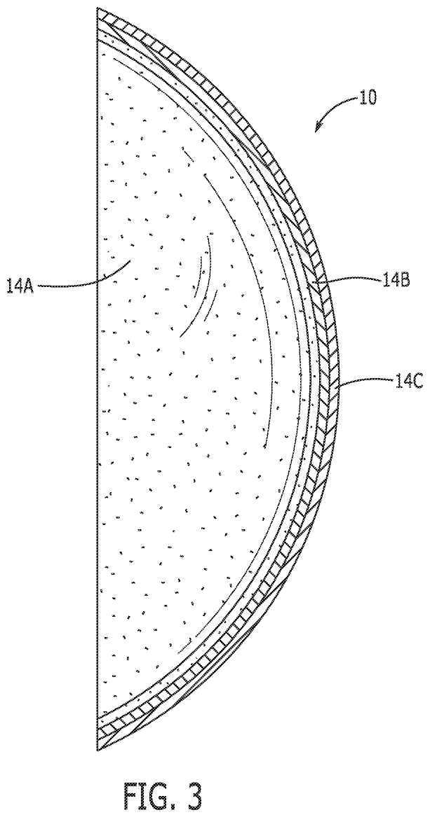

Referring to FIGS. 1 through 3, FIG. 1 illustrates a lens cover 10 according to an embodiment of the present invention mounted to a lens 12A of a camera 12 on the rear of an automobile 11. As shown in FIGS. 2 and 3, the lens cover 10 comprises an inner pressure-sensitive adhesive layer 14A, a middle protective film layer 14B affixed to an exterior surface of the pressure-sensitive adhesive layer 14A, and an exterior hydrophobic coating layer 14C coated onto the middle protective film layer 14B.

It should be understood, of course, that the foregoing relates to exemplary embodiments of the invention and that modifications may be made without departing from the spirit and scope of the invention as set forth in the following claims.

What is claimed is:

1. A transparent multilayer protective film for electromagnetic devices, comprising:
a barrier film having a first surface and a second surface;
a hydrophobic polymer coated onto the first surface of the barrier film; and
a pressure sensitive adhesive adhered to the second surface of the barrier film.

2. The transparent multilayer protective film of claim 1, wherein the barrier film is formed of polyurethane.

3. The transparent multilayer protective film of claim 1, wherein the barrier film is configured to conform to a lens and has a convex surface and a concave surface, and wherein the hydrophobic polymer is on the convex surface and the pressure sensitive adhesive is on the concave surface.

4. The transparent multilayer protective film of claim 1, wherein the barrier film and/or the hydrophobic coating is self-healing.

5. A method of protecting an electromagnetic device, comprising:
providing the transparent multilayer protective film of claim 1; and
applying the pressure sensitive adhesive to the electromagnetic device;
wherein the electromagnetic device is selected from the group consisting of: a camera; a gun sight; a radar sensor; an infrared sensor; and a LIDAR sensor.
